(19) United States
(12) Patent Application Publication
(10) Pub. No.: US 2020/0125174 A1
(43) Pub. Date: Apr. 23, 2020

(54) TACTILE FEEDBACK DEVICE AND ELECTRONIC DEVICE EQUIPPED WITH SAID TACTILE FEEDBACK DEVICE

(71) Applicant: NIDEC COPAL CORPORATION, Tokyo (JP)

(72) Inventors: Yoshinori OIKAWA, Tokyo (JP); Hideaki KAMIJO, Tokyo (JP); Hiroyuki HORI, Tokyo (JP); Hiroyuki SUZUKI, Tokyo (JP)

(73) Assignee: NIDEC COPAL CORPORATION, Tokyo (JP)

(21) Appl. No.: 16/471,888

(22) PCT Filed: Dec. 15, 2017
(86) PCT No.: PCT/JP2017/045141

§ 371 Date: Jun. 20, 2019

(30) Foreign Application Priority Data
Dec. 27, 2016 (JP) 2016-254233

(51) Int. Cl. G06F 3/01; G06F 3/041

(52) U.S. Cl. CPC G06F 3/016; G06F 3/041

(57) ABSTRACT

In order to obtain a desirable sensation of pressing upon a touch input unit, this tactile feedback device is configured so as to comprise a case body, a touch input unit which is pressed toward the inner side of the case body by a touch operation, a vibration actuator which is fixed to the touch input unit so as to be integrated therewith and which vibrates according to the touch operation, and an elastic support member which supports the touch input unit on the case body, where the elastic support member is extended along a direction which intersects with a pressing direction P in which the touch operation is performed, with one part of the elastic support member in said extension direction being fixed to the touch input unit and another part thereof in said extension direction being fixed to the case body.

### CROSS-REFERENCE TO RELATED APPLICATIONS

This application is a National Stage Application of International Application PCT/JP2017/045141 filed Dec. 15, 2017, publishing as WO 2018/123661 on Jul. 5, 2019, and claiming priority to Japanese Application No. 2016-254233 filed Dec. 27, 2016. The above applications are incorporated herein by reference in their entirety.

### FIELD OF TECHNOLOGY

The present invention relates to a tactile feedback device configured so as to cause a touch inputting portion to vibrate in response to a touch operation, and relates to an electronic device comprising this tactile feedback device.

### BACKGROUND

Touch panels are user interfaces that generally combine a touch sensor and an image displaying device, and, by a user performing a touch operation on an operating surface that overlays a display screen, a signal corresponding to the displayed image is outputted. Moreover, the touchpad is an input device wherein the operating surface inputs a signal through a touch by the user, where normally an electronic device that is provided with a touchpad is equipped with a display portion that is separate from the operating surface of the touchpad. While it is possible for the user to identify visually, through the display of the displayed image, that a signal has been inputted through the touch inputting portion, such as the touch panel or touchpad, the user is unable to obtain the “feel of operation” that is present with a stroke, such as there is when a button on a keyboard has been pressed.

In relation to this, in recent years there has been research into technology to produce skin tactile feedback (tactile technology) through the interface providing a force, vibration, movement, or the like, to the user, and there have been proposals for feedback of vibration to, for example, the finger of the user who has performed an operation in touch inputting portions as well.

A device wherein the back face of a touch panel that has a vibrating portion is supported on a case through an elastic damper made from an elastic material is known as this type of tactile feedback device (referencing Japanese Unexamined Patent Application Publication 2013-59756).

### SUMMARY

However, in the prior art set forth above, when the touch panel is pushed and through a touch operation, the elastic damper is deformed through compression, so the feeling of pressing is dull, making it impossible to have a good “pressed feeling.” There are also cases wherein, depending on the part that is touched, only one part of the touch panel will be pressed deeply, while another part will be in a floating state, making it impossible to have a good “pressed feeling.”

Moreover, the vibration of the vibrating portion is lost through the elastic damper, so in some cases it is not possible to produce adequate feedback through vibration, or responsiveness of the vibration is lost.

In contemplation of such a problem, the present invention is provided with the following structures:

A tactile feedback device having a case; a touch inputting portion that is pressed into the inside of the case through a touch operation; a vibration actuator that is secured integrally with the touch inputting portion, and that vibrates in response to the touch operation; and an elastic supporting member for supporting the touch inputting portion, wherein: the elastic supporting member is provided extending in a direction that is perpendicular to the pressing direction by the touch operation, with a portion thereof, in the direction of extension, secured to the touch inputting portion, and another portion thereof secured to the case.

### BRIEF DESCRIPTIONS OF THE DRAWINGS

FIG. 1 is an exterior perspective diagram depicting an example of a tactile feedback device according to the present invention.

FIG. 2 (a) is a perspective diagram viewed from the front side, and (b) is a perspective diagram viewed from the back side, for the interior structure of the example of FIG. 1.

FIG. 3 depicts a perspective assembly view of the example of FIG. 1.

FIG. 4 depicts an expanded cross-sectional view of critical portions of the example of FIG. 1t.

FIG. 5 (a) is a perspective diagram viewed from the front side, and (b) is a perspective diagram viewed from the back side, for the interior structure of another example of a tactile feedback device according to the present invention.

FIG. 6 depicts a perspective assembly view of the other example.

FIG. 7 depicts an expanded cross-sectional view of critical portions of the other example.

FIG. 8 depicts an expanded cross-sectional view of critical portions of a further example.

FIG. 9 depicts an expanded cross-sectional view of critical portions of a yet further example.

FIG. 10 depicts a perspective assembly view of an additional example.

FIG. 11 is a perspective diagram of only the elastic supporting member that is used in the additional example.

FIG. 12 depicts a back assembly view of the additional example.

FIG. 13 depicts a cross-sectional assembly view of the additional example.

FIG. 14 is a perspective diagram depicting an example of an electronic device equipped with a tactile feedback device according to the present invention.

### DETAILED DESCRIPTION

Examples according to the present invention will be explained below, in reference to the drawings. Identical reference symbols in the different drawings below indicate essentially identical structures, and redundant explanations are omitted as appropriate.

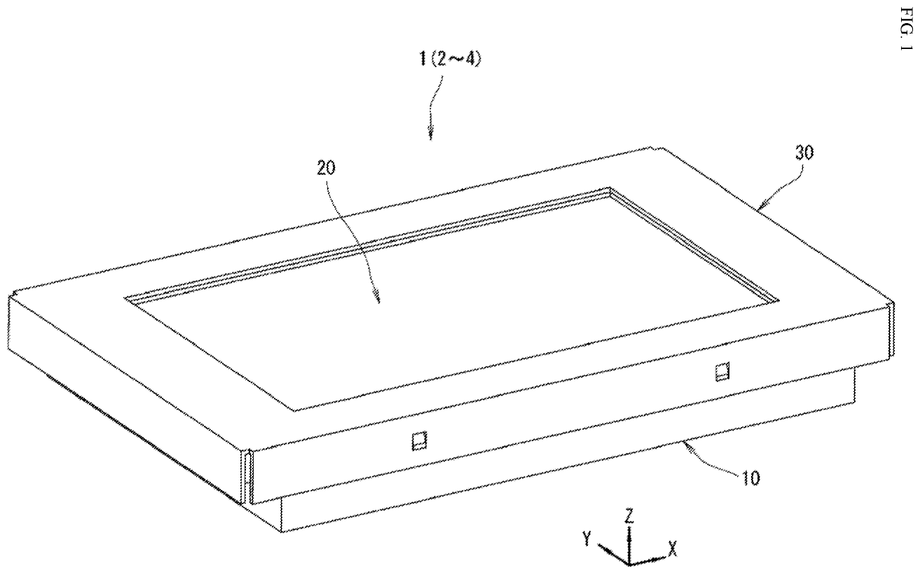

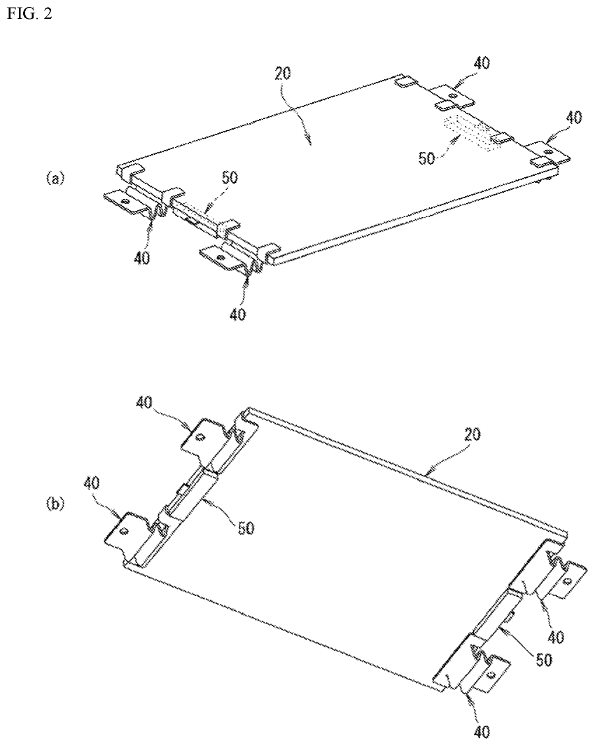

A first example of a tactile feedback device according to the present invention is depicted in FIG. 1 through 4.

This tactile feedback device 1 has a case 10; a touch inputting portion 20 that is pressed into the case 10 by a touch operation; a cover member 30 that is fastened to the case 10 so as to cover the peripheral edge side of the touch inputting portion 20; an elastic supporting member 40 for supporting the touch inputting portion 20 on the case 10; a vibration actuator 50, secured integrally with the touch inputting portion 20, for vibrating in accordance with the touch operation; and an image displaying portion 60 that is positioned further toward the pressing direction side than the touch inputting portion 20.

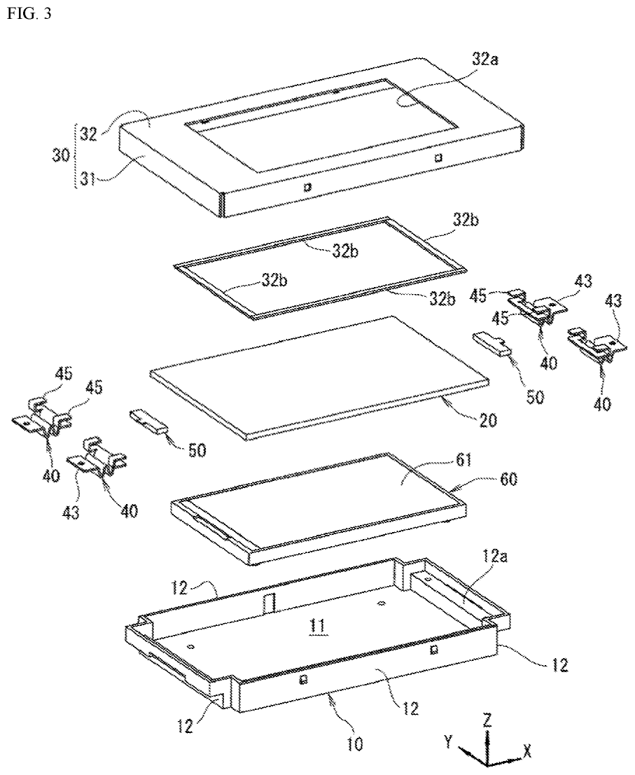

The case 10 is formed from a hard material such as, for example, a hard synthetic resin or a metal material, in essentially the shape of a box that is open on the side that is in the direction that is opposite of the direction of pressing (the Z direction side in the drawings) (referencing FIG. 3).

This case 10 has a bottom wall portion 11 of a rectangular flat plate shape, and side wall portions 12 that protrude from each of the edges of the bottom wall portion 11 in the direction that is opposite of the direction of pressing.

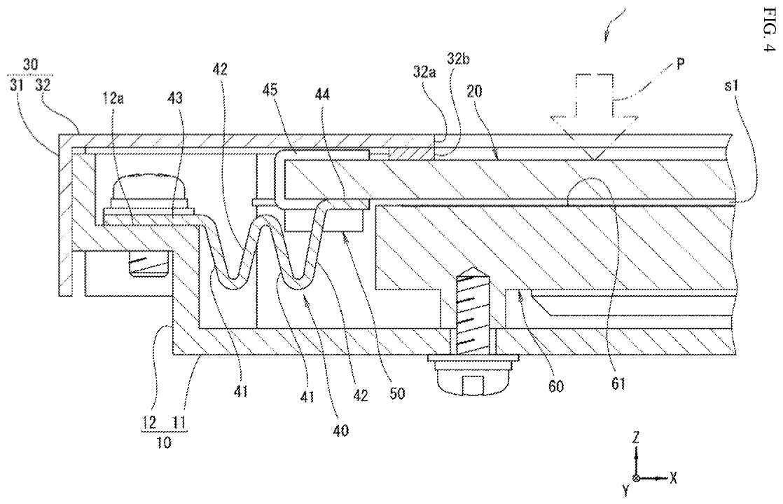

Of the side wall portions 12 on the four edge sides, the side wall portions 12 on two edges that are opposite of each other on two sides each has a stepped portion 12a on the inner surface thereof (referencing FIG. 4). This stepped portion 12a is formed in a flat shape that is perpendicular to the pressing direction P, and supports an elastic supporting member 40, described below.

The touch inputting portion 20 is a transparent touch panel of a rectangular flat plate shape, wherein the exposed surface portion is configured so as to output a signal when there is a touch operation with a finger, or the like. A touch panel may be used that has, for example, a pressure sensitive (resistive film-type) sensor at this touch inputting portion 20, but touch panels that use electrostatic capacitance-type sensors or other types of sensors may also be used.

The touch inputting portion 20 is supported, by the elastic supporting member 40, described below, so as to enable slight movement toward the inside of the case 10 (the Z direction in the figures) and slight movement in the direction of retraction of the elastic supporting member 40 (the X direction in the figures).

The peripheral end portions of the touch inputting portion 20 are positioned so as to not contact the surrounding members (the side wall portions 12, screws, or the like) (referencing FIG. 4). Moreover, the surface portions on the peripheral end sides of the touch inputting portion 20 are adjacent to, or make sliding contact with, the back face of the cover member 30, through an elastic member 32b.

The cover member 30 is formed as a single unit from four side wall portions 31 that each overlaps with the outer surface of the side wall portions 12 of the four edge sides of the case 10, and a frame plate portion 32 that covers the opening of the case 10 and wherein the peripheral edge sides are connected to the side wall portions 31. A rectangular opening portion 32a, for exposing the touch inputting portion 20, described below, is formed in the center of the frame plate portion 32 (referencing FIG. 4).

Moreover, a band-shaped elastic member 32b is secured to the back face of the frame plate portion 32 so as to run along the inner edge of the opening portion 32a (referencing FIG. 3 and FIG. 4).

This frame plate portion 32 is for preventing entry, into the case 10, of contamination, or the like, from between the surface of the touch inputting portion 20 and the back face of the frame plate portion 32; however, this made be omitted instead.

Elastic supporting members 40 may be provided at each of the four corners of the touch inputting portion 20, as illustrated in FIG. 4.

Each of the elastic supporting members 40 is a spring member, provided extending in the direction that is perpendicular to the direction of pressing P by the touch operation (the lengthwise direction of the touch inputting portion 20 in the example in the figures), that can extend and compress elastically in the direction of extension thereof, and can bend elastically in the direction of pressing P, having one end side thereof, in the direction of extension thereof, secured to the back face of an end portion side of the touch inputting portion 20, and the other end side thereof secured to a stepped portion 12a of the case 10.

The material for the elastic supporting member 40 should be a material that is able to extend and compress in the direction of extension thereof, and able to bend in the pressing direction P, and may use, for example, a metal material for springs, a synthetic resin material that can deform elastically, or the like.

In this elastic supporting member 40, as depicted in the cross-section in FIG. 4, one pieces 41 that are inclined toward the pressing direction P side from the fastening location on the side wall portion 12 side of the case 10 toward the fastening location on the touch inputting portion 20 side, and other pieces 42 that are inclined in the direction that is opposite of the pressing direction (the Z direction of the figures) from the fastening location on the case 10 side toward the fastening location on the touch inputting portion 20 side, are connected alternatingly. The cross-sectional shape is continuous in the direction of depth in FIG. 4 (the Y direction).

Additionally, the flat plate-shaped connecting piece 43 is continuous with the side wall portion 12 side of the elastic supporting member 40, where this connecting piece 43 is laid on the stepped portion 12a of the side wall portion 12, and secured through a fastener, such as a screw, or the like. Moreover, the flat plate-shaped connecting piece 44 is continuous with the touch inputting portion 20 side of the elastic supporting member 40, and this connecting piece 44 is layered together with the back face of the touch inputting portion 20, and secured thereto through an adhesive agent.

Moreover a fitting portion 45, which has a box-shaped cross-section, is provided on the side of the connecting piece 44 in the direction that is opposite of the pressing direction, so as to face an end portion of the touch inputting portion 20 (referencing FIG. 3 and FIG. 4). An end portion side of the touch inputting portion 20 is inserted and secured in this fitting portion 45.

The fitting portion 45 may be, for example, fused to the connecting piece 44, or may be formed integrally with the connecting piece 44.

Moreover, the vibration actuator 50 is in the shape of a rectangular solid, and is configured so as to vibrate in the short direction.

Such vibration actuators 50 are provided on one lengthwise direction end and the other lengthwise direction end of the touch inputting portion 20. Each vibration actuator 50 is configured so as to vibrate in the direction of extension of the elastic supporting member 40 (the extension/compression direction), and is secured to the back face of the touch inputting portion 20 (between elastic supporting members 40 that are lined up in the Y direction in the example in the figures).

As a specific example of the vibration actuator 50, it may be a mechanism that causes a movable element to undergo reciprocating motion through attractive forces and repulsive forces that are produced between magnets, through magnetism, when electric power is applied to a driving coil.

The image displaying portion 60 is a rectangular plate-shaped liquid crystal display device that has an image displaying surface 61 on the side in the direction that is opposite the direction of pressing, and displays, on an image displaying surface 61, an image in response to an image signal that is inputted from a controlling circuit, not shown.

The image displaying portion 60 is disposed essentially in parallel with the back face of the touch inputting portion 20, with a gap s1 therebetween (referencing FIG. 4), and secured to the bottom wall portion 11 of the case 10 through a fastener, such as a screw or a bolt.

The gap s1 is set as appropriate so that when the touch inputting portion 20 is pressed in, through a normal touch operation, the back face of the touch inputting portion 20 will not contact the image displaying surface 61, and so that when the touch inputting portion 20 is pressed into the case 10 through a touch operation that is stronger than normal, the back face of the touch inputting portion 20 will contact the image displaying surface 61, limiting the distance to which the touch inputting portion 20 is pressed.

Additionally, the tactile feedback device 1, structured as described above, is controlled through a controlling circuit (for example, a microcontroller, or the like, not shown) that is provided either within the case 10 or outside of the case 10, to vibrate the touch inputting portion 20 in response to a signal when there is a touch operation on the touch inputting portion 20.

The distinctive effects of the operation of the tactile feedback device 1, structured as described above, will be explained in detail next.

When there is a touch operation on the surface of the touch inputting portion 20 by a finger of a user, the touch inputting portion 20 is pushed into the inside of the case 10 by the pressing force of the touch operation.

At this time, the touch inputting portion 20 causes the two elastic supporting members 40 and 40, on each side, to flex elastically, so that the entirety of the touch inputting portion 20 will move essentially in parallel toward the inside of the case 10, without tilting so as to be partially depressed, as in the prior art, thereby providing, to the user, a good “pressed feeling,” such as being pressed quickly with a light pressing force.

Given this, as described above, when the touch inputting portion 20 is pressed, essentially simultaneously therewith, or immediately thereafter, the vibration actuator 50 vibrates, and this vibration is transmitted to the touch inputting portion 20, to vibrate the touch inputting portion 20.

At this time, the touch inputting portion 20 vibrates in the direction of extension and compression of the elastic supporting members 40, enabling the production of a relatively large vibration, with little suppression by the elastic supporting members 40, and with good responsiveness as well.

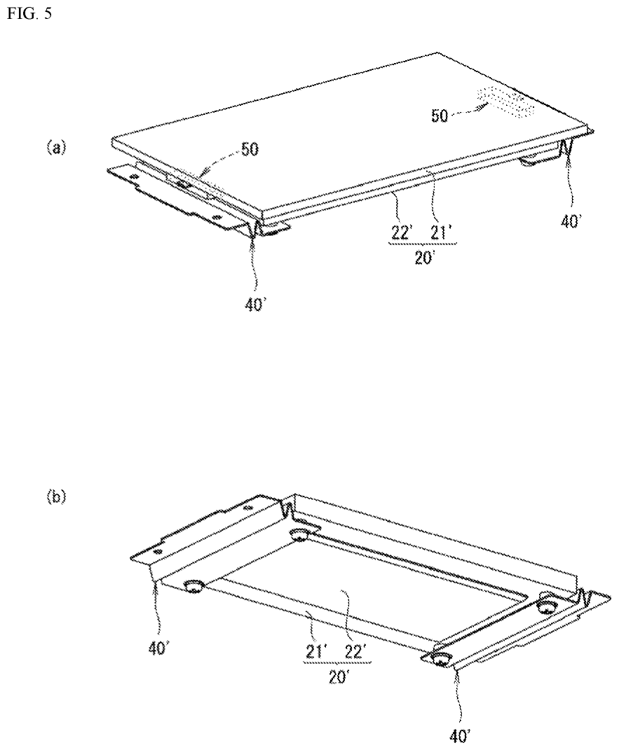

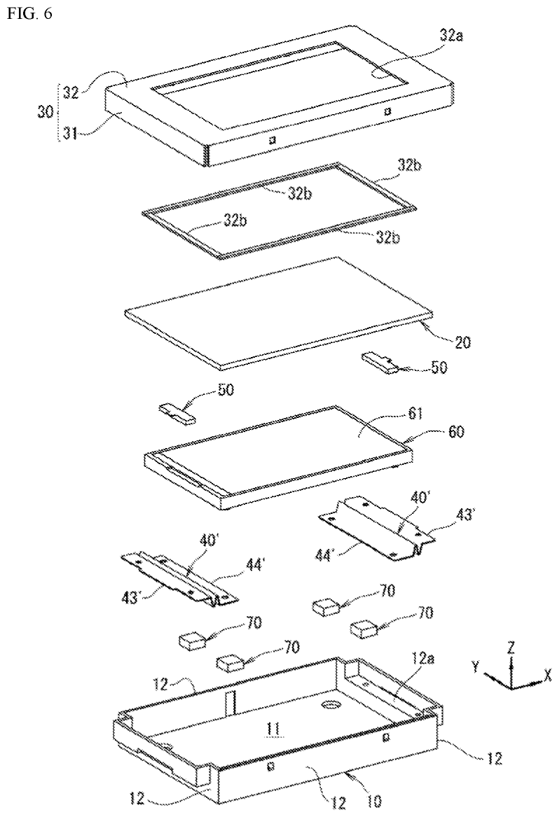

Another example of a tactile feedback device according to the present invention will be explained next (referencing FIG. 5 through 7).

In this tactile feedback device 2, the interior structure is partially modified in respect to the tactile feedback device 1 described above, and the external appearance is identical to the tactile feedback device 1 described above (referencing FIG. 1).

Explaining in detail, in the tactile feedback device 2, when compared to the tactile feedback device 1: the touch inputting portion 20 and the image displaying portion 60 have been replaced with a touch inputting portion 20′ that has, integrally, an image displaying portion 22; the elastic supporting member 40 is replaced with an elastic supporting member 40′; and an elastic bearing portion 70 has been added.

In the touch inputting portion 20′, as illustrated in FIG. 5, a transparent touch panel 21′ and image displaying portion 22′ are provided integrally, and is supported, by the elastic supporting member 40′, described below, so as to enable slight movement toward the inside of the case 10 (the Z direction in the figures), and slight movement in the direction of extension and compression of the elastic supporting member 40′ (the X direction in the figures).

The touch panel 21′ is structured identically to the touch panel that structures the touch inputting portion 20, described above.

The image displaying portion 22′ is structured identically to the image displaying portion 60, described above, and is secured integrally to the back face of the touch panel 21′.

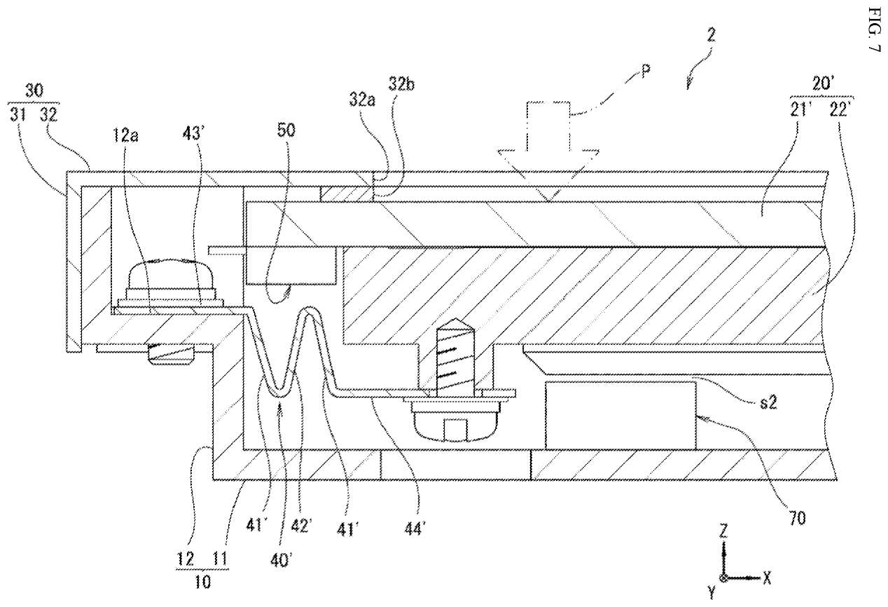

The peripheral end portions of the touch panel 21′ and image displaying portion 22′ are positioned so as to not contact the surrounding members (the side wall portions 12, screws, or the like) (referencing FIG. 7). Moreover, the surface portions on the peripheral end sides of the touch inputting portion 20′ are adjacent to, or make sliding contact with, the back face of a frame plate portion 32 of the cover member 30, through an elastic member 32b.

As illustrated in FIG. 5, two elastic supporting members 40′ are provided so as to be positioned on one end side and the other end side in the lengthwise direction of the touch inputting portion 20′ (specifically, of the image displaying portion 22′).

Each of the elastic supporting members 40′ is a spring member, provided extending in the direction that is perpendicular to the direction of pressing P by the touch operation (the X direction), that can extend and compress elastically in the direction of extension thereof, and can bend elastically in the direction of pressing P, having one end side thereof, in the direction of extension thereof, secured to the back face of an end portion side of the image displaying portion 22′, and the other end side thereof secured to a stepped portion 12a of the side wall portion 12 of the case 10 (referencing FIG. 7).

The materials for the elastic supporting member 40′ are the same as for the elastic supporting member 40, described above.

In this elastic supporting member 40, as depicted in the cross-section in FIG. 7, one pieces 41′ that are inclined toward the pressing direction P side from the fastening location on the side wall portion 12 side of the case 10 toward the fastening location on the image displaying portion 22′ side, and other pieces 42′ that are inclined in the direction that is opposite of the pressing direction (the Z direction of the figures) from the fastening location on the case 10 side toward the fastening location on the touch inputting portion 20 side, are connected alternatingly. The cross-sectional shape is continuous along essentially the entire length of the short edge of the image displaying portion 22′.

Additionally, the flat plate-shaped connecting piece 43′ is continuous with the side wall portion 12 side of the elastic supporting member 40′, where this connecting piece 43′ is laid on the stepped portion 12a of the side wall portion 12, and secured through a fastener, such as a screw, or the like. Moreover, a flat plate-shaped connecting piece 44′ is continuous with the image displaying portion 22′ side of the elastic supporting member 40′, and the connecting piece 44′ is secured by a fastener (for example, a screw, a bolt, or the like) to the back face of the image displaying portion 22′.

In this second embodiment, the vibration actuator 50 is secured directly to the touch panel 21. That is, as illustrated in FIG. 7, an end portion side of the touch panel 21′ protrudes beyond the end portion side of the image displaying portion 22′, and the vibration actuator 50 is secured directly to the back face of the protruding part. The direction of vibration of the vibration actuator 50 is the same as the direction of extension and compression of the elastic supporting member 40′.

Moreover, the elastic bearing portion 70 is formed in the shape of a block from an elastic material such as, for example, rubber, elastomer resin, or the like, and is secured to the inner surface of the bottom wall portion 11 in the case 10 through an adhesive material.

This elastic bearing portion 70 is provided in a plurality corresponding to suitable locations, such as at each of the four corners of the image displaying portion 22′, for example, to bear the back face of the image displaying portion when moved to the pressing direction side, where the bearing surface is caused to retract elastically.

A gap s2 is provided between the elastic bearing portion 70 and the initial position of the back face of the image displaying portion 22′ (referencing FIG. 7).

The gap s2 is set as appropriate so that when the touch inputting portion 20′ is pressed in, through a normal touch operation, the back face of the image displaying portion 22′ will not contact the elastic bearing portion 70, and so that when the touch inputting portion 20′ is pressed into the case 10 through a touch operation that is stronger than normal, the back face of the image displaying portion 22′ will contact the elastic bearing portion 70, limiting the distance to which the touch inputting portion 20 is pressed.

When the touch inputting portion 20′ is pressed more strongly than normal, the elastic bearing portion 70 bears the back face of the image displaying portion 22′, and undergoes elastic deformation.

Note that as another example, not illustrated, the elastic bearing portion 70 may be omitted, in which case a gap that is similar to the gap s2, described above, is provided between the back face of the image displaying portion 22′ and the inner surface of the bottom wall portion 11.

Through this, in the same manner as with the tactile feedback device 1, with the tactile feedback device 2 the entirety of the touch inputting portion 20′ moves essentially in parallel toward the inside of the case 10 at the time of a touch operation, providing the operator with a good “pressed feeling” of pressing in smoothly and quickly with a light pressure.

Additionally, Because the touch inputting portion 20′ vibrates in the direction of extension and compression of the elastic supporting member 40′ either essentially simultaneously with, or immediately following, the touch inputting portion 20′ being pushed in, that vibration tends to not be suppressed by the elastic supporting member 40′, enabling a relatively large vibration to be produced, with good responsiveness as well.

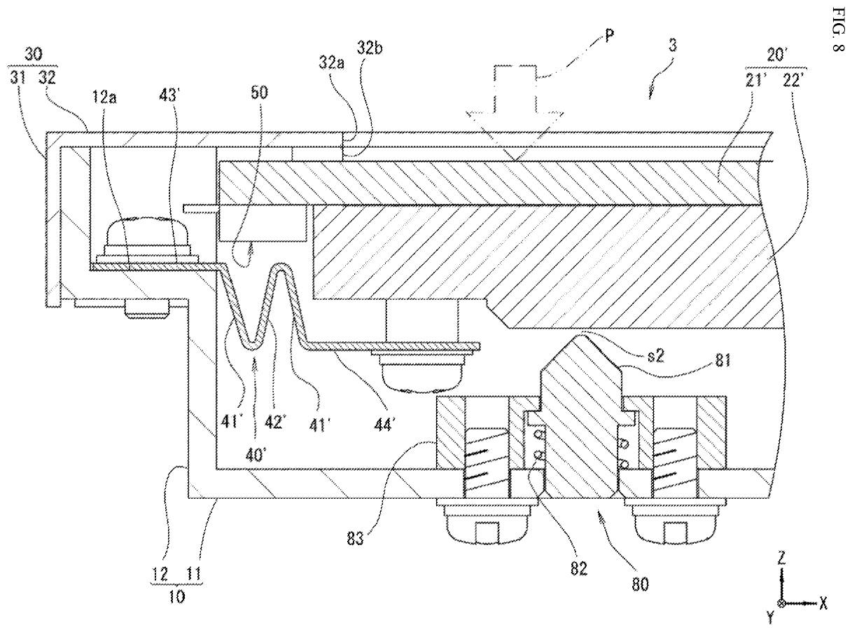

A further example of a tactile feedback device according to the present invention will be explained next (referencing FIG. 8).

In this tactile feedback device 3, the interior structure is partially modified in respect to the tactile feedback device 2 described above, and the external appearance is identical to the tactile feedback devices 1 and 2 described above (referencing FIG. 1).

In this tactile feedback device 3, when compared to the tactile feedback device 2, described above, the elastic bearing portion 70 is replaced with an elastic bearing portion 80.

The elastic bearing portion 80 comprises: a contacting member 81, for making point contact with the back face of the image displaying portion 22′ when pressed, an elastic member 82 for supporting the contacting member 81 elastically, and a bracket 83, for holding the contacting member 81 and the elastic member 82, to thereby bear the back face of the image displaying portion 22′ when moved toward the pressing direction side, so that the elastic member 82 is caused to move back elastically.

The contacting member 81 is a member wherein the part on the side in the direction opposite of the direction of pressing is in the form of an essentially circular cone shape, and the part on the side in the pressing direction is formed in a circular column shape. In the contacting member 81, the protruding end portion on the side in the direction opposite of the pressing direction is formed in with convex curved surface where the cross-section is an arc shape, and, when pushed in, contacts the back face of the touch inputting portion 20′ (and specifically, of the image displaying portion 22′). A metal material or a hard synthetic resin material, or the like, is used for the material of the contacting member 81.

A gap s2 is secured between the contacting member 81 and the initial position of the back face of the image displaying portion 22′ (referencing FIG. 8).

The elastic member 82 is a coil-shaped compression spring equipped in a ring shape in the part of the contacting member 81 on the side that is in the pressing direction. One of the seat portions of this elastic member 82 is in contact with a flange portion that is provided on the outer periphery of the contacting member 81, and the other seat portion is in contact with the bottom face of the case 10.

The bracket 83 is a hollow member that has an opening in the face on the side that is in the direction that is opposite the direction of pressing. The bracket 83 allows a portion of the contacting member 81 to protrude from the opening, and covers the contacting member 81 and the elastic member 82, and is secured to the bottom face of the case 10 by a fastener, such as a screw, a bolt, or the like.

Given the tactile feedback device 3, structured as described above, when the touch inputting portion 20′ is pressed, the vibration actuator 50 vibrates essentially simultaneously therewith, or immediately thereafter, and the touch inputting portion 20′ vibrates accompanying this vibration. At this time, when the push is relatively large, the back face of the image displaying portion 22′ makes point contact with the protruding tip of the contacting member 81, and the contacting member 81 causes the elastic member 82 to undergo elastic deformation, to be pushed back.

Consequently, this makes it possible to produce essentially the same “pressed feeling” and vibration as with the tactile feedback devices 1 and 2, described above.

Furthermore, when the touch inputting portion 20′ is pressed, the back face of the image displaying portion 22′ makes point contact with the protruding end of the contacting member 81, thus making it possible to prevent any suppression of the magnitude of vibration due to frictional resistance, or the like, with the contacting part.

Note that although, in the form described above, the contacting member 81 is caused to make point contact with the back face of the image displaying portion 22′, as another example of a contacting member, it may instead make line contact with the back face of the image displaying portion 22′.

In this case, the contacting member is formed with the protruding end side shaped with a cross-section that is essentially an inverted V shape, and is continuously in the Y direction in, for example, FIG. 8. Given this, the elastic member for supporting the contacting member is a leaf spring that extends in the Y direction, a plurality of coil springs, or the like, and the bracket that covers these is also formed so as to be long in the Y direction (not shown).

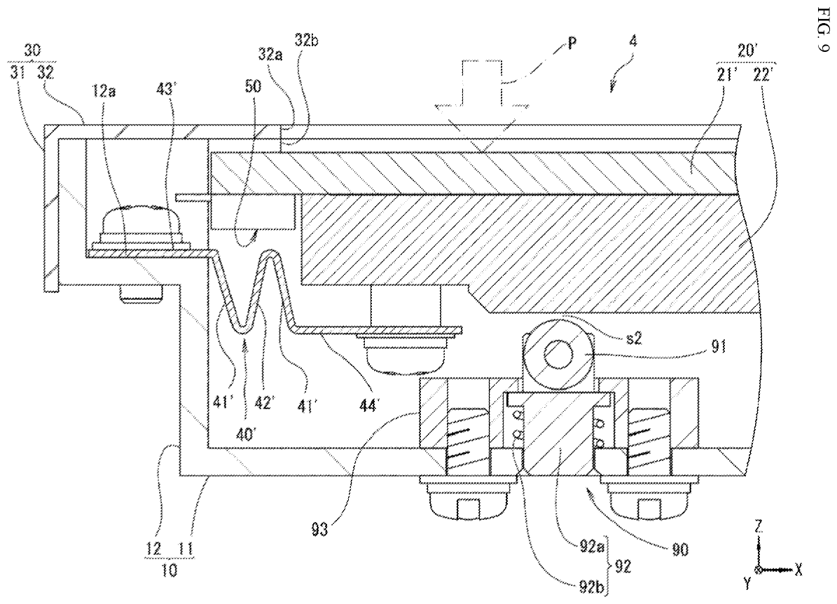

An example of a tactile feedback device according to the present invention will be explained next (referencing FIG. 9).

In this tactile feedback device 4, the interior structure is partially modified in respect to the tactile feedback device 2 described above, and the external appearance is identical to the tactile feedback devices 1 through 3 described above (referencing FIG. 1).

In this tactile feedback device 4, when compared to the tactile feedback device 3, described above, the elastic bearing portion 80 is replaced with an elastic bearing portion 90.

The elastic bearing portion 90 comprises: a rolling member 91 wherein, when pressed, the outer peripheral surface contacts the back face of the touch inputting portion 20′ (and specifically, of the image displaying portion 22′); an elastic supporting portion 92 for supporting the rolling member 91 elastically so as to enable rotation thereof; and a bracket 93, for holding the rolling member 91 and the elastic supporting portion 92; to thereby bear the back face of the image displaying portion 22′ when moved toward the pressing direction side, and the rolling member 91 is pushed back elastically.

The rolling member 91, as illustrated, is a cylindrical roller that is supported so as to roll along the back face of the image displaying portion 22′, along the direction of vibration of the image displaying portion 22′ (the X direction).

The rolling member 91 is supported by the elastic supporting portion 92 so as to enable rotation.

A gap s2 is secured between the rolling member 91 and the initial position of the back face of the image displaying portion 22′ (referencing FIG. 9).

The elastic supporting portion 92 comprises a supporting member 92a that supports the rolling member 91 so as to enable rotation thereof, and that is able to extend and retract in the Z direction, and an elastic member 92b that biases the supporting member 92a in the direction that is opposite of the pressing direction.

The supporting member 92a may be in a form, for example, wherein the rotary shaft of the rolling member 91 is supported on both sides thereof so as to enable rotation, in a form wherein the rolling member 91 is born in an arc shape so as to enable rotation, or the like.

The part of the supporting member 92a on the side in the pressing direction is formed in a circular column shape, and the elastic member 92b is equipped in a ring shape on this circular column-shaped part. This elastic member 92b is a coil-shaped compression spring, where one seat portion makes contact with a flange portion that is provided on an outer periphery of the supporting member 92a, and the other seat portion is makes contact with the bottom face of the case 10.

The bracket 93 is a hollow member that has an opening that enables the rolling member 91 to protrude. The bracket 93 is fastened to the bottom face of the case 10 by a fastener, such as a screw, a bolt, or the like, so as to cover the supporting member 92a and the elastic member 92b.

Given this tactile feedback device 4 when the touch inputting portion 20′ is pressed, the vibration actuator 50 vibrates essentially simultaneously therewith, or immediately thereafter, and the touch inputting portion 20′ vibrates accompanying this vibration. At this time, when the push is relatively large, the back face of the image displaying portion 22′ makes contact with the outer peripheral surface of the rolling member 91, and the rolling member 91 and supporting member 92a cause the elastic member 92b to undergo elastic deformation, to be pushed back.

Consequently, this makes it possible to produce essentially the same “pressed feeling” and vibration as with the tactile feedback devices 1 through 3, described above.

Furthermore when the touch inputting portion 20′ is pressed, the back face of the image displaying portion 22′ contacts the outer peripheral surface of the rolling member 91, and the rolling member 91 rolls along the direction of vibration of the touch inputting portion 20′, thus making it possible to prevent any suppression of the magnitude of vibration due to frictional resistance, or the like, with the contacting part.

Note that while in the form described above, the rolling member 91 with was formed in a circular column roller shape, as another example, the rolling member may be formed as a sphere, where this spherical rolling member may be supported by a supporting member in a concave shape so as to enable rotation (not shown).

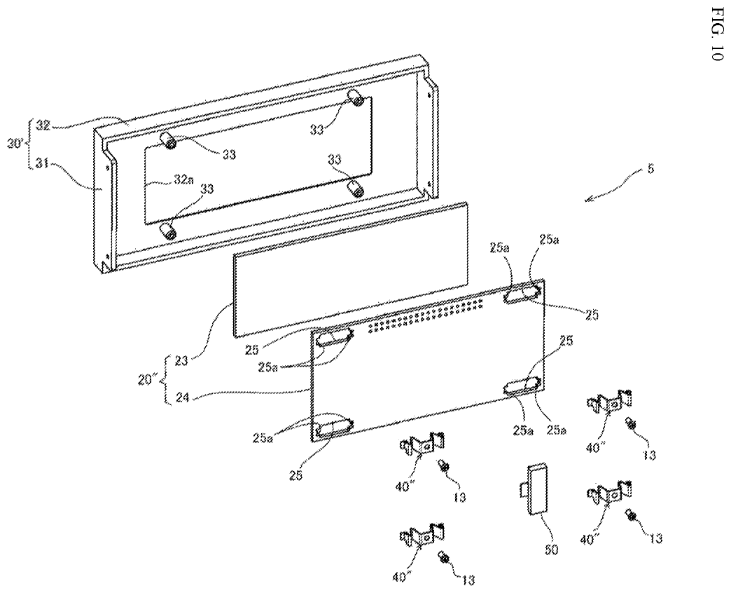

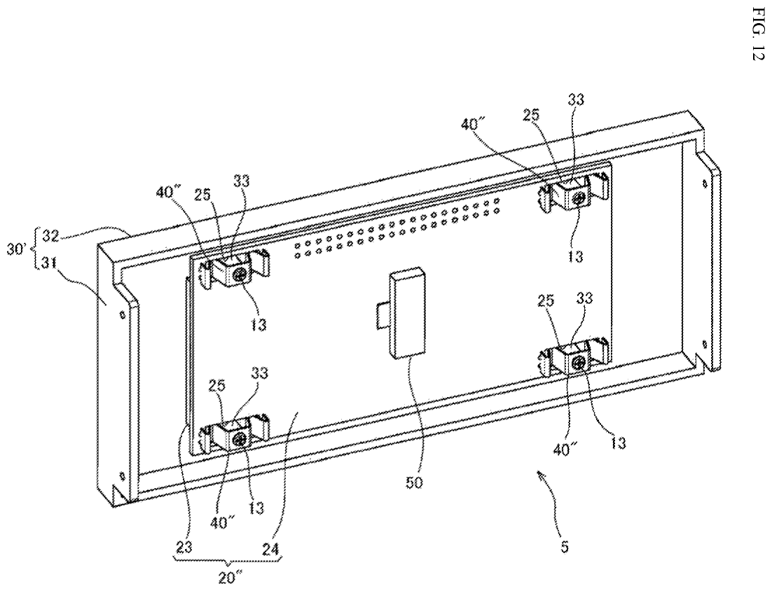

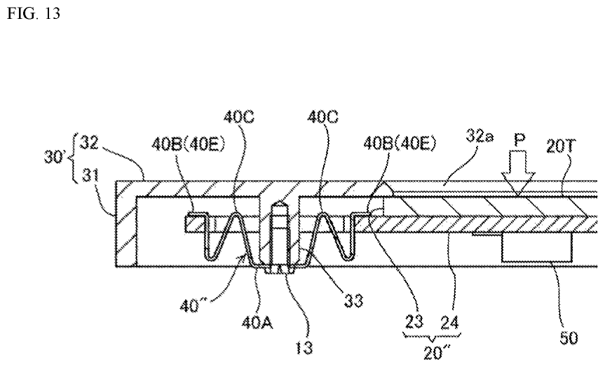

Yet another example of a tactile feedback device according to the present invention will be explained next (referencing FIG. 10 through 13).

The tactile feedback device 5 is provided with a structure enabling the touch inputting portion 20″ to be attached easily to the cover member 30′. In this example, the cover member 30′ is the case that supports the touch inputting portion 20″, making possible to omit, as appropriate, the case 10 in the embodiments described above.

The cover member 30′ comprises a frame plate portion 32 that has an opening portion 32a that exposes the inputting surface 20T of the touch inputting portion 20″, and a fastening portion 33, for fastening the touch inputting portion 20″, is provided on the back face of this frame plate portion 32. The fastening portion 33 is provided in a plurality around the periphery of the opening portion 32a, so as to protrude from the back face of the frame plate portion 32 (in four locations in the figures).

The touch inputting portion 20″ comprises a touch cover glass 23 and a printed substrate 24, where the touch cover glass 23 is attached to the surface of the printed substrate 24, to structure the touch inputting portion 20″. Opening portions 25 are provided at positions corresponding to the fastening portions 33, described above, in the printed substrate 24. The opening portion 25 is open along the direction of extension of the elastic supporting member 40″, described below, and engaging portions 25a, for fastening the elastic supporting member 40″, are provided on the edge portions on both ends thereof in the direction of extension. Note that the opening portion 25 may be provided in a cut-out shape that is open toward the side of the printed substrate 24, as long as an engaging portion 25a is provided in the direction of extension of the elastic supporting portion 40″.

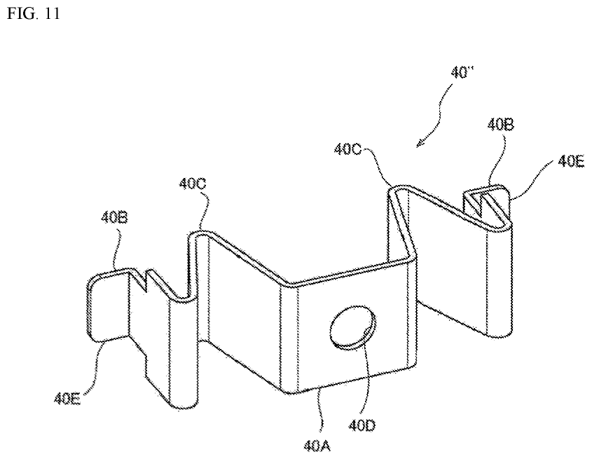

The elastic supporting member 40″, as a single unit, comprises a fastening hole 40D in a center portion 40A, as depicted in FIG. 11, where engaging portions 40E are provided on both end portions 40B, and elastically deformable portions 40C are provided between the center portion 40A and the end portions 40B. As with the elastic supporting members 40 and 40′, described above, the elastic supporting member 40″ is also provided extending across the direction that is perpendicular to the pressing direction P by the touch operation, and is a plate-shaped spring member that can extend and compress elastically in the direction of extension thereof, and that can bend elastically in the pressing direction P.

The vibration actuator 50 is secured integrally to the printed substrate 24 in the touch inputting portion 20″ in the example in the figure. While, in this example, the vibration actuator 50 is secured to the back face side of the printed substrate 24, there is no limitation thereto, but rather the touch cover glass 23 may, for example, extend to the outside of the printed substrate 24, and the vibration actuator 50 may be secured directly to the touch cover glass 23.

In assembling such a tactile feedback device 5, first, in the touch inputting portion 20″, the elastic supporting member 40″ is enclosed within the opening portion 25 of the printed substrate 24, and the end portions 40B (the engaging portions 40E) of the elastic supporting member 40″ are engaged with the engaging portions 25a of the opening portion 25. Through this, the elastic supporting member 40″ will be held within the opening portion 25 in a state wherein both end portions 40B are secured to the edge portions of the opening portion 25.

Given this, the fastening portions 33 of the cover member 30′ are inserted into the opening portions 25 for holding the elastic supporting member 40″, and screws 13 are inserted into the fastening holes 40D that are provided in the center portions 40A of the elastic supporting members 40″, to secure the center portions 40A of the elastic supporting members 40″ to the fastening portion 33. Through this, the touch inputting [portion] 20″ will be supported through the elastic supporting members 40″ on the cover member 30′ that is the case.

Given this tactile feedback device 5, as with the tactile feedback devices 1 through 4, described above, when the touch inputting portion 20″ is pressed, the vibration actuator 50 vibrates essentially simultaneously therewith, or immediately thereafter, and the touch inputting portion 20″ vibrates accompanying this vibration. Consequently, this makes it possible to produce essentially the same “pressed feeling” and vibration as with the tactile feedback devices 1 through 4, described above.

Additionally, the tactile feedback device 5, through using the cover member 30′ as the case and supporting the touch inputting portion 20″, enables the case 10, described above, to be omitted, enabling the device to be made thinner. Moreover, because the touch inputting portion 20″ can be secured to the cover member 30′ through the elastic supporting member 40″ in a state wherein the elastic supporting member 40″ is engaged with the touch inputting portion 20″ in advance, this can simplify the assembly operations.

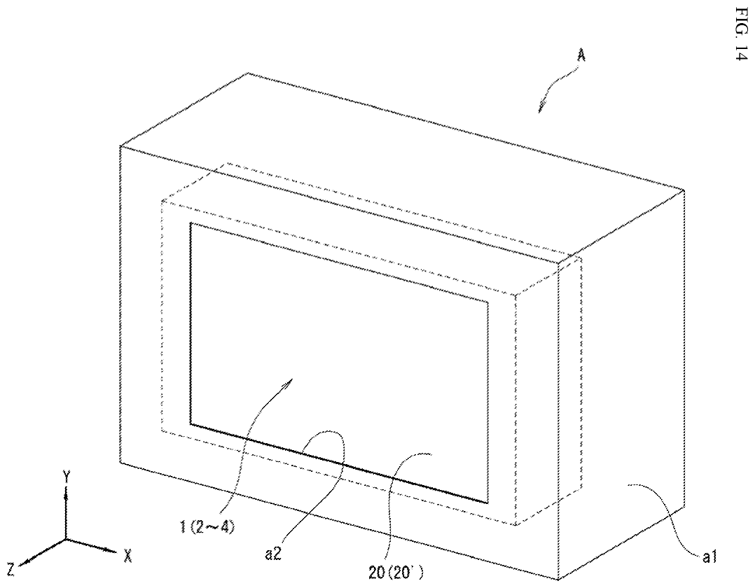

FIG. 14 is an example illustrating an electronic device A comprising any of the tactile feedback devices having the structures described above.

The electronic device A has an opening a2 on one face of a case a1, where the touch inputting portion 20 or 20′ is exposed through this opening a2, and any of the tactile feedback devices 1 through 5 is equipped within the case a1.

Specific examples of this electronic device A include home electronics devices, game machines, various types of compound electronic devices, medical devices, vehicle-mounted devices such as navigation systems, and the like.

These electronic devices A can provide a good feeling of operation to the user who performs a touch operation on the touch inputting portion 20 or 20′, and also has good responsiveness to the operation.

Note that as another example of an electronic device A, it may be one wherein any of the tactile feedback devices above 5 is used as-is as the device listed above, without the provision of the case a1.

As yet another example, a smart phone or mobile telephone, a tablet terminal, a PDA (Personal Digital Assistant), a touch-screen personal computer, some other wearable electronic device, or the like, may be structured using any of the tactile feedback devices 1 through 5, or a touchpad for a personal computer or a touchpad for another electronic device may be structured therefrom.

While in the specific forms of embodiment described above, touch sensors were provided in the touch panel that structures the touch inputting portion 20 or 20′, as another example, it may be a form wherein the touch sensor is provided at a location other than the image displaying portion or a touch panel, rather than providing the touch sensor on the touch panel.

Moreover, while, in the embodiments described above, leaf springs were used as particularly preferred elastic supporting members, insofar as the elastic supporting member is an elastic member with one end side secured to the touch inputting portion and the other end side secured to the case, a coil spring, a rubber, an elastic synthetic resin material, or the like, for example, may be used instead.

Moreover, while, in the embodiments described above, as a particularly preferred example the vibration actuator 50 was provided so as to vibrate in the direction of extension of the elastic supporting member 40, 40′, or 40″ (the X direction in the figures), as other examples the direction of vibration thereof may be the direction of thickness of the touch inputting portion 20 (the Z direction in the figures), or a direction that is perpendicular to the direction of extension, along the surface of the touch inputting portion 20 (the Y direction in the figures).

Moreover, while, in the first through fourth examples described above, as a particularly preferred example the vibration actuator 50 was provided on one end side and the other end side, in the direction of vibration, of the touch inputting portion 20 or 20′, as another example there is a form wherein a vibration actuator 50 is provided on just one end side, a form wherein a vibration actuator 50 is provided on one side or both sides in the direction that is perpendicular to the direction of vibration, a form wherein a vibration actuator 50 is provided on the peripheral end face of the touch inputting portion 20 or 20′, a form wherein a vibration actuator 50 is provided toward the center on the back face of the touch inputting portion 20 or 20′, a form wherein three or more vibration actuators 50 are provided, and so forth, where the locations and numbers of vibration actuators 50 may be different from the examples that are illustrated.

While the embodiments of the present invention were described in detail above, the specific structures are not limited to those in these embodiments, but rather design changes, and the like, within a range that does not deviate from the spirit or intent of the present invention are included within the present invention. Moreover, insofar as there are no particular contradictions or problems in purposes or structures, or the like, the technologies of the various embodiments described above may be used together in combination.

1. A tactile feedback device comprising:
a case;
a touch inputting portion on which a touch operation is performed;
a vibration actuator secured integrally with the touch inputting portion, and that vibrates in response to the touch operation; and
an elastic support supporting the touch inputting portion on the case so as to be pressed in by the touch operation, wherein:
the elastic support is provided extending in a direction that is perpendicular to the pressing direction by the touch operation, with a portion thereof, in the direction of extension, secured to the touch inputting portion, and another portion thereof secured to the case.

2. The tactile feedback device as set forth in claim 1, wherein:
the vibration actuator is provided so as to vibrate in the direction of extension of the elastic support.

3. The tactile feedback device as set forth in claim 1, wherein:
the elastic support can extend and compress in the direction of extension, and is a spring member that can bend in the pressing direction.

4. The tactile feedback device as set forth in claim 3,
wherein the elastic support is formed in the shape of a leaf spring,
wherein one piece is inclined toward the pressing direction side from the fastening location on the case side toward the fastening location on the touch inputting side,
wherein another piece is inclined toward the side in the direction away from the direction of pressing from the fastening location on the case side toward the fastening location on the touch inputting portion side, and
wherein the pieces are connected alternatingly.

5. The tactile feedback device as set forth in claim 1, wherein:
the touch inputting portion is a transparent touch panel, and the image displaying portion is provided further toward the pressing direction side than the touch panel, with a gap therebetween.

6. The tactile feedback device as set forth in claim 1, wherein further comprising:
an elastic bearing portion, bearing the back face of the touch inputting portion and compressing elastically when the touch inputting portion is moved toward the pressing direction side, is provided further toward the pressing direction side than the touch inputting portion.

7. The tactile feedback device as set forth in claim 6, wherein:
the elastic bearing portion is formed from an elastic material.

8. The tactile feedback device as set forth in claim 6, wherein the elastic bearing portion comprises:
a contacting member making a point contact or a line contact with the back face of the touch inputting portion when the touch inputting portion is pressed; and
an elastic member for supporting the contacting member elastically.

9. The tactile feedback device as set forth in claim 6, wherein the elastic bearing portion comprises:
a rolling member wherein the outer peripheral surface contacts the back face of the touch inputting portion when the touch inputting portion is pressed; and
an elastic supporting portion supporting the rolling member elastically so as to enable rotation thereof.

10. The tactile feedback device as set forth in claim 1, wherein in the elastic support, one end portion in the direction of extension thereof is secured to the touch inputting portion, and the other end portion is secured to the case.

11. The tactile feedback device as set forth in claim 1, wherein both end portions in the direction of extension are secured to the touch inputting portion, and the center portion thereof is secured to the case.

12. The tactile feedback device as set forth in claim 11, wherein:
the touch inputting portion comprises an opening portion that is open along the direction of extension of the elastic supporting member;
the elastic support ii held within the opening portion in a state wherein both end portions thereof are secured to the edge portions of the opening portion; and
the case is equipped with a fastening portion wherein the center portion of the elastic support is inserted into the opening portion and secured.

13. The tactile feedback device as set forth in claim 12, wherein the case is a cover member that exposes the inputting surface of the touch inputting portion.

14. An electronic device comprising a tactile feedback device as set forth in claim 1.
